(19) United States
(12) Patent Application Publication
(10) Pub. No.: US 2007/0043578 A1
(43) Pub. Date: Feb. 22, 2007

(54) Method and system for norming and/or standardizing product features

(76) Inventors: Rainer Betz, Treuchtlingen (DE); Norbert Kaiser, Roth (DE); Hubert Tauschek, Berg (DE); Uwe Wiederhold, Wiesbaden (DE)

Correspondence Address: Siemens Corporation;Intellectual Property Department, 170 Wood Avenue South, Iselin, NJ, 08830, US

(21) Appl. No.: 11/206,367

(22) Filed: Aug. 18, 2005

(51) Int. Cl. G06Q 99/00; G07G 1/00; G06F 17/30; G06F 11/34

(52) U.S. Cl. 705/1; 705/10; 705/11

(57) ABSTRACT

A method and system for norming and/or standardizing product features, wherein the product features are defined by characteristic elements. A pool (e.g. a data base or a product catalog) comprising product features and characteristic elements is accessed bin a defined and controlled way to ensure that all data entries are based on a norm or a standard. This improves the interchangeability of in particular technical data within a company and also enables the exchangeability of in particular technical data between companies (CRM). Another aspect of the invention is a method and a system for searching a product, wherein the product features are defined by standardized elements or components.

### FIELD OF THE INVENTION

The invention generally relates to a method and a system for adapting a content of a norm, and a method for searching a product in the field of electronic procurement systems.

### BACKGROUND OF THE INVENTION

Electronic shopping systems exist which allow users or clients to remotely buy goods and services via a communications network such as the Internet from a supplier or a provider. There are electronic shopping systems for nearly all kinds of market segments comprising B2C (business to consumer) and B2B (business to business) markets. The recently fast developments in this area are summarized under the buzzwords E-Business, E-Commerce, online-marketplace, or E-Procurement.

US 2004/0117263 A1 provides a method, a server system, and a computer program product for handling the user registration process, in particular with respect to registration in an electronic commerce system, such as a business to business electronic commerce procurement system.

US 2003/0074279 A1 provides an E-Procurement system having a portal server supporting a robust procurement system providing a wide range of features that purchasing and procurement applications require including storing capabilities for various purchasing and procurement functions in a business environment.

WO 02/057889 A2 provides methods for providing and conducting electronic procurement and a host architecture for an electronic procurement site.

Searching products or services is normally conducted using a product catalog. For a supplier offering its products and services in an online market place it is important that a customer finds a desired product or service fast and easily. Furthermore it must be assured that the customer receives the product or service which he is really looking for. Therefore the product and service specification in the product catalog must be clear, well-defined and distinct. For this reason the E-Procurement system on the provider or supplier side must assure that the entries in the product catalog are commonly understood and the specifications of an entry in the product catalog point univocally to the desired product or service on the customer side.

### SUMMARY OF THE INVENTION

One aspect of the invention is a method for norming and/or standardizing product features, wherein the product features are defined by characteristic elements, the method comprising: providing a norm comprising characteristic elements regarding the product features; providing a pool of product features and characteristic elements; providing a search mechanism for defining a search pattern based on the norm, wherein the search pattern comprises the characteristic elements provided by the norm; searching the pool based on at least one search pattern; and modifying the pool of product features and characteristic elements by evaluating a hit list obtained by the search.

Another aspect of the invention is a system for norming and/or standardizing product features, wherein the product features are defined by characteristic elements, the system comprising: a pool of product features and characteristic elements, wherein the features and characteristic elements are based on a norm or a standard; a search mechanism for defining a search pattern based on the norm or the standard, wherein the search pattern comprises the characteristic elements provided by the norm or the standard; and a mechanism for modifying the product features and characteristic elements by evaluating a hit list provided by the search mechanism.

A further aspect of the invention involves a method for searching a product, comprising: providing a norm; providing a search catalog including a plurality of search patterns based on the norm for searching products included in a product pool; searching the product pool based on at least one search pattern; modifying the at least one search pattern and the norm using an evaluation of a hit list obtained by the search; and adapting the content of the norm according to the modified search pattern.

### BRIEF DESCRIPTION OF THE DRAWINGS

The above-mentioned and other concepts of the present invention will now be addressed with reference to the drawings of the preferred embodiments of the present invention. The shown embodiments are intended to illustrate, but not to limit the invention. The drawings contain the following figures, in which like numbers refer to like parts throughout the description and drawings and wherein:

FIG. 1 shows a first schematic block diagram of an electronic procurement system,

FIG. 2 shows a second schematic block diagram of an electronic procurement system,

FIG. 3 shows the architecture of an exemplary server computer,

FIG. 4 shows an exemplary structure of an order to enter or change a feature or product group of the data base,

FIG. 5 shows an exemplary HMI of the feature or product group order management (search function),

FIG. 6 shows an example of the data model of the data base core,

FIG. 7 shows a further example of the data model of the data base part using ETIM 2.0 and Eclass 4.0 standards,

FIG. 8 shows an exemplary structure of a configurated feature,

FIG. 9 shows an exemplary HMI for feature search by feature element,

FIG. 10 shows in a schematic diagram an overview of an exemplary sequence in the order management and feature configuration, and

FIGS. 11-15 show in an exemplary chronology in the order management regarding a feature and product group.

### DESCRIPTION OF THE PREFERRED EMBODIMENTS

One aspect of E-business is E-Procurement. When a company needs a specific component, e.g. a programmable controller or a drive, for a factory or a machine, the purchasing department of this company is searching in sources (e.g. databases) provided by possible suppliers. The suppliers normally provide their searchable sources in proprietary Internet portals or so called online market places.

After drawing up a list of the requirements of the needed component, the company is faced with the following questions:
1. How and where can I find a suitable component?
2. What does it cost and how quickly can I get the needed component?
3. How do I best use it?

The first question addresses the search for the right product. The customer who is searching for a product has several ways to gather information about the products different suppliers have to offer:

The customer can use the traditional way: e.g. personal consultations, catalogs, product descriptions in advertisements, queries submitted to possible suppliers in written form or via the telephone, or the customer can use a more advanced electronic way. E-business provides additional information channels where a customer can gather information: e.g. online catalogs, e-mail news letters, online marketplaces, information provided by push technologies, or company-wide ERP systems with supplier-specific product data.

The second question addresses the problem “how to get a chosen product?”, this comprises the aspects: current price and availability of the chosen product, order-placing, order-confirmation, time to deliver, and status of delivery. E-business supports these aspects manifold: e.g. all important information, such as current price and availability of a product are available for customers 24 hours on 7 days online, orders can be confirmed electronically on request, tracking & tracing of the product delivery is provided online, and normally E-business systems allow a seamless integration of the ordering process in existing IT structures of the customer.

The third question addresses the problems which can occur on the customer site during commissioning or optimization of a plant or system in which the product is to be integrated. Traditional support mechanisms are supplier's hotline, manuals and documentations, and product and system training offered by the supplier. E-business offers additional support mechanisms: e.g. extensive knowledge databases with search options, discussion forums for exchanging experience and information with other users, Internet pages containing the answers to frequently asked questions (FAQs) about products, and online training using the Internet.

An E-procurement system has to cover the whole chain from gathering information about a product, selecting the product, ordering, tracking, and support and training on the customer site.

Because of the Internet, company wide intranets, coupling of intranets of several companies, or fast connection mechanism with high band with and data rates customers and suppliers can be integrated. E-business activities such as E-procurement are using these mechanisms to save time and costs and provide benefits to the customer and to the supplier. E-procurement is also a good mechanism to strengthen the relationship between customer and supplier (Customer Relationship Management, CRM). Furthermore an integrated, stable, and efficient E-procurement system supports a company-wide resource planning system (ERP) that links together, for example production systems, financial systems, personnel systems, sales systems, and materials management systems.

An important aspect of E-procurement on the supplier site is customer satisfaction. Only a satisfied customer will become or continue a regular customer. The customer satisfaction can be adversely affected and impaired in of the E-procurement chain: gathering information about a product, selecting the product, ordering, tracking, and support and training on the customer site. In particularly the step selecting the product is very crucial to customer satisfaction. When a customer selects the wrong product, for example when the chosen product does not fulfill the customer requirements, costs occur on the customer side in the purchasing department (negotiations with the supplier, efforts for shipping back the old product, and selecting and ordering a new product) and on the shop floor (increased efforts and time for acceptance test, putting the component into operation, down time of the plant or plant component). When after commissioning and during operation of the selected and delivered component it turns out that the component is the wrong component and the component does not cover the formulated and expected requirements, the costs for replacing or scrap are even higher.

The present invention provides methods and mechanisms to reduce the error rate by selecting and ordering a product using E-procurement.

A concept of the invention is that normed and standardized technical data are provided in a searchable data base, wherein the normed and standardized technical data are based on company internal norms or official standards, such us ETIM, DIN V4002, IEC, or eClass. Company internal norms or standards are an important aspect when integrating departments of a company and when introducing integrated workflows in a company. Company internal norms or standards are also a prerequisite to establish an ERP system in a company. When the products and services offered by a supplier are based on company internal norms or standards it is ascertained that the different product and service provider within the company who feed their products and services in the data base of the E-procurement system or who amend existing products or services already in the data base due to new developments or updates so that they have the same understanding and use the same terminology regarding the products and services in the data base. Therefore a data base of an E-procurement system whose entries are based on company internal norms or standards provides a mechanism so that the terminology used in different departments of a company is the same, so that misunderstandings regarding the entries (products and services) of the data base are avoided. Company internal norms or standards ensure also a clear and unique description of the data base entries, which prevents errors on provider side and on customer side, because one voice to the customer is provided.

When the normed and standardized technical data of the searchable data base of the E-procurement system are based on official standards, such us ETIM, DIN V4002, IEC, or eClass, the customer who is searching for a product or service has a clear understanding and imagination of the products and services which are provided the supplier. This reduces the probability that the customer is selecting and ordering a wrong product or service.

A further advantage is present when the entries of a data base providing products or services for customers by suppliers are normed and standardized technical data. These data can be used for a data exchange, in particular master data exchange between customer and supplier. When the data to be exchanged are based on a norm or standard, the ERP systems (or other IT systems, e.g. Management Execution Systems (MES)) of the customer and the supplier can easily be coupled and connected.

Therefore the invention enables normed and standardized technological alignments within a company and between customer and suppliers.

Another concept of the invention is that the entries of the data base are aligned and adjusted according to a norm or a standard. When the content and the structure of the data of the data base are adjusted according to a norm or a standard, then the data are unique, reproducable and interchangeable. The aspect of interchangeability of data is very important for a company regarding the integration of company internal processes and regarding the integration to processes of third parties (e.g. external supplier or customer).

Often the same data are used in different business processes of a company (e.g. content providing for a catalog, in offers, electronic data processing) and the same data are often represented and stored in different media (e.g. print media, electronic data carrier, Internet, Intranet, Extranet, electronic auctions). When the data are not adjusted according a norm or a standard often manually adjustments or mappings of the data are necessary to interchange the data. This is time consuming and onerous.

Data pools and data bases can be organized as spread sheets (e.g. Excel), relational data bases (e.g. Access), web sites in a Markup language (e.g. HTTP, XML, EXML), and the data pools can be stored on a hard drive, a floppy disc, a CD-ROM, a DVD, USB-sticks, or file-transfer server. Normally only data formats of different data pools are interchangeable or can be mapped from one format to another format (e.g from Excel to Access). But the contents of the data and the semantics of the data are not easily interchangeable between different data pools, because the structuring of the content in the data pools is different and the data are not compatible. Therefore the exchanging of data between different data pools requires efforts (manual adjustments or mappings) on sender side and on receiver side. Furthermore the sender and the receiver of the data have to come to an agreement before every data exchange. This is awkward and time consuming.

Another concept of the invention is to provide a mechanism (Feature Generator) to adjust the entries of a data pool or a data base according a norm or a standard. The mechanism (e.g. web based HMI) supports a user creating or amending entries of the data pool. A user has access to the data pool only by using the Feature Generator, this ensures that the entries of the data pool are created or changed only according to the rules and regulations of the Feature Generator. The Feature Generator comprises a search function to find a data entry (e.g. a product or a service) or to find a feature of a product or a service. A product consists of features, and a feature consists of predefined elements. The features and elements are built according to a norm or a standard. To ensure that the features and elements are built according to a norm or a standard, the Feature Generator provides to the user a dialog with questions to lead the user to a product or a feature. The questions are ordered to find a product or a feature easily and fast. Therefore, the first question asks for concise and crucial statements regarding a product or a feature (e.g. voltage range, number of pins, size). This allows a user to put products and features in concrete and standardized form. Therefore also other users have a common understanding of a product and a feature, because the content and the semantics of a data entry (representing a product or a feature) are clear and unique. The Feature Generator provides a semi-automatic building and amending of data entries representing products and features, because after completion of the questions by the user, the Feature Generator provides a hit list of possible features and elements which can be used by the user to create or amend a data entry. If the Feature Generator does not provide a suitable feature or element, the data base of the Feature Generator has to be extended.

The Feature Generator offers the following advantages, among others:
automatic clustering of product groups of the data pool,
the data entries of the data pool can be independently processed in a company or in different companies,
data exchange, in particular master data exchange, of technical data is possible in a company or between companies,
unique terminology and semantics of the data entries (products, services, features, elements),
the search results are reproducible, this means it doesn't matter where to start the questions, a user will be led by the Feature Generator always to the same hit list and results,
all entries of the data pool are based on a norm or a standard (e.g. ETIM, DIN V4002, IEC, or eClass),
reduced variety of products,
standardized terminology,
the information in the data pool is structured, clear, and reproducible,
unique data structures (syntax) and unique understanding (semantics) of the data entries,
before exchanging data, no longer manual adjustments or mappings, or discussions between sender and receiver of the data are necessary,
the data can easily be integrated in an electronic work flow of a company (in MES or ERP systems),
the data entries can be used in ERP systems of a customer or a supplier, and
the data entries can be used in documentations (e.g. product documentation, advertisements, or product catalogs).

In the following the Feature Generator is described in more detail. The Feature Generator can be used as access interface to a data base containing features (each feature is represented as a data structure having elements (e.g. attributes) which describe the feature in detail). The Feature Generator can also be used as access interface to a data base containing products or descriptions of products, the products are described by features comprising elements.

The Feature Generator provides an administration view and a use view. The administration view offers a tool kit of predefined elements which can be used to formulate a feature. The definition of an element is based on a norm or a standard. Therefore an element has a unique and clear meaning and semantic. To create a new feature or to amend an existing feature, the Feature Generator provides to the user a search function and a questionnaire. The search function and the questionnaire support the user to find a relevant feature or element. With the aid of the search function and/or the questionnaire the user defines a search pattern. The search provides a hit list. The user can select a feature or an element from the hit list. The hit list can be evaluated by the user. Possible evaluation criteria are: number of results, accuracy and exactness of the search, or failure rate of the results. The hit lists can be stored and used for a continuously improvement of the search mechanism. If, after a search, the Feature Generator does not provide a feature or an element, the data base of the Feature Generator has to be extended. The questionnaire provides a dialogue to the user which makes the search more effective. The questionnaire begins with questions regarding profound statements about a product, feature, or element, to limit the possible search results. A search can be extended by additional information which can be used in a free search (free textual search in the whole data base). Furthermore the Feature Generator comprises rules how to combine the elements. This allows that the results of a search are reproduceable and repeatable. This means that every search with the same input parameters results always in the same output results: These element-combining rules advantageously reduce the variety of variants in a search.

The use view of the Feature Generator offers the user the possibility to identify a feature or element of the administration view using the terminology and wording the user is used to use (e.g. terminology regarding markets, trades, industrial sectors, technologies). The use view provides a mapping from common (usual, normal) terminology to standardized and normed terminology (provided by the administration view). Using the definitions and descriptions of the administration view the user can verify whether these standardized and normed definitions and/or descriptions correspond to the terminology and wording of the use view. The use view provides a bridge and mapping between the necessary abstractions of the administration view and the terminology and wording which is in common use. The mapping can be accomplished for example by spread sheets, by tables (containing pointers to relevant products, features or elements) or by any other mapping mechanism between different domains (e.g. name domains or value domains). Advantageously, the mapping mechanism enables a surjective mapping so that for all elements of common terminology an element of normed terminology can be gained.

The Feature Generator enables for example an electrical appliance wholesaler to classify and process products from different suppliers using one system. So the wholesaler does not need product catalogs or data bases dedicated to the different suppliers. Therefore a product group can be clustered regardless the suppliers. And furthermore the wholesaler can easily couple his IT system or data base to the systems of customers or suppliers.

The Feature Generator may be accessed by different ways and mechanisms. A user can have direct access to the Feature Generator and the data base which can be manipulated by the Feature Generator. It is also possible that a special group or person is responsible to access the Feature Generator and maintain the data entries. This person or group collects the proposals for new entries or amending existing entries (an entry can be a product or service, a feature, or an element) and performs the input by using the Feature Generator. The access to the Feature Generator can be protected by passwords or other authorization mechanisms. A controlled access to the Feature Generator avoids rank growth of the data base. Advantageously, a proposal for a new entry or for amending an existing entry is transmitted to the person or group collecting the proposals in form of an official order. Each order has a defined structure, so that the intention of the order is clear and each order is traceable, so that the submitter of the order can keep track about the status of the order.

The Feature Generator may be used directly as access mechanism to a data pool or a catalog containing products and services of a supplier which are offered in an online market place or an E-procurement system to possible customers. Because the data entries of the data pool or the catalog are based on a norm or standard, the error rate on customer side in selecting and ordering a wrong product will be low.

The Feature Generator may also be used as an access mechanism to a data base containing only features and elements (a feature consists of elements). This offers the advantage that within a company all groups and departments use the features and elements of the data base to describe a product or a service. When the products and services of a company are described only by the features and elements of this data base a common understanding is ascertained.

The Feature Generator is adaptable to different environments (the data base can vary, different types of Browser can be used as HMI, the access to the Feature Generator can be protected by authorization mechanisms, etc.), and is easy to maintain, because commercials of the shelf (COTS) can be used to implement the Feature Generator. The Feature Generator can be a web application (web server or web client) and can be implemented advantageously in Java, this enables an easy deployment in web applications. But also other programming languages can be used to implement the Feature Generator.

The Feature Generator can be used for all kinds of products: consumer devices, electrical appliances, components for power plants, transportation systems, manufacturing plants, medical devices, etc.

The data base of the Feature Generator can be a data pool of products, or feature and elements, or a search catalog which can be offered by a supplier to customers which are looking for products which fulfill defined requirements. The data base can be implemented in a relational data base which is easily to maintain, or the data base can be implemented using a Markup language (e.g. HTTP, XML or XML dialects) which enables and supports a web based use of the Feature Generator.

The Feature Generator can be integrated in a Manufacturing Application System (MES) and/or an Enterprise Resource and Planning (ERP) system of a company. This enables an efficient data exchange and an adjusted workflow in the company and between the IT systems of the company. Because the Feature Generator provides product descriptions which are based on a norm or standard, data pools or search catalogs maintained by the Feature Generator can easily be integrated into E-procurement systems ERP systems of third parties (e.g. customer, supplier).

The Feature Generator can be used to norm and standardize product features. This allows for the products to be comparable to each other, even when they are provided by different manufacturers. The Feature Generator can also be used in a search mechanism to find and select products, which should fulfill defined requirements. This can advantageously be used in an E-procurement system providing a product pool and a search catalog to find and select adequate products or services.

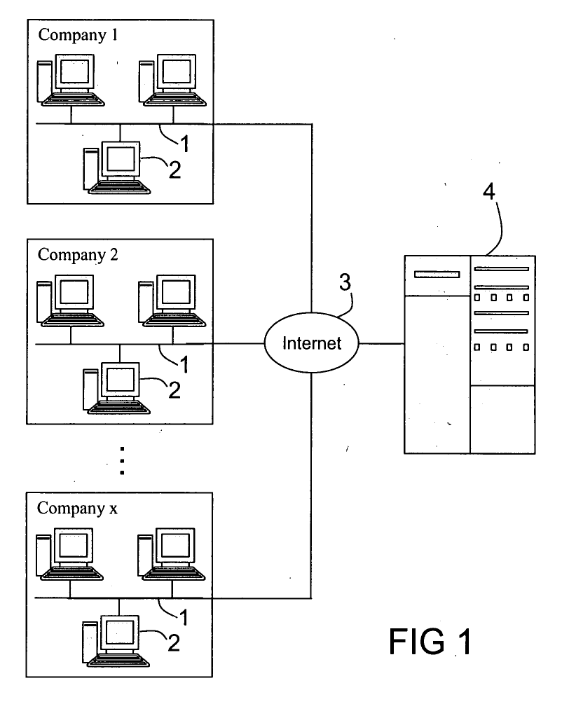

FIG. 1 shows a schematic block diagram of an electronic business system, for example an E-procurement system. The E-procurement system relies on a network, such as the Internet 3, as a communication means between the participants of the E-procurement system. In the example considered here a number x of companies participate in the E-procurement system. Each of the companies has a communications network 1, for example an intranet or a LAN connection means. Each communications network 1 is coupled to the Internet 3 through a gateway, and each of the communications network 1 has a number of client computers 2 which are accessible to employees of the respective companies. The server computer 4 is also coupled to the Internet 3 such that the server computer 4 can be accessed from each client computer 2 of the different companies. The server computer 4 comprises for example an online market place in which one ore more suppliers offer products to customers. A customer can be a company 1 through x, or a client computer 2. The server computer provides interfaces to the customers and to the at least one supplier of services and/or products. The services or products are stored in the server computer 4 by means of a searchable data base. The Feature Generator 10 ensures that the entries of the data base are defined according to a standard or a norm. The online market place provides an online catalog for viewing and selecting goods (e.g. products and services) by the customers. Normally the online market place comprises also a virtual shopping cart for storing and viewing customer selected goods which have not yet been purchased, and a payment procedure as well as a logistic component (for keeping track of purchased goods).

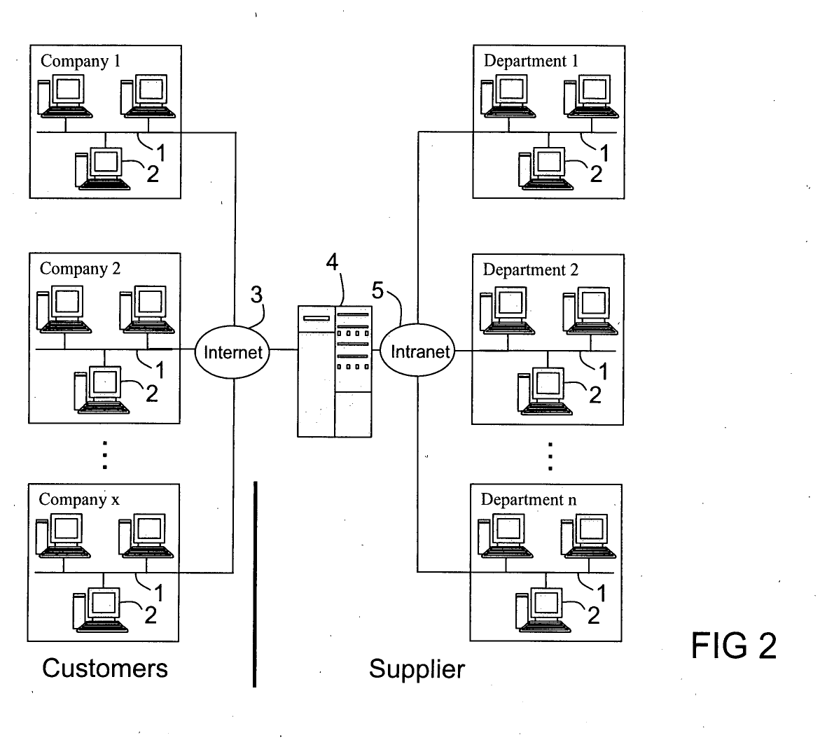

FIG. 2 shows a further schematic block diagram of an E-business or electronic procurement system. In the embodiment shown in FIG. 2 the server computer 4 is connected to customers via the Internet 3 and to suppliers via an intranet 5, because the suppliers are different departments 1 through n of the same company. In a department, client computers 2 are connected via a communications network 1 (e.g. LAN or intranet). Advantageously, an Internet connection from the suppliers to the server computer 4 is used if the suppliers are from different companies. The Feature Generator 10 ascertains that the products and services, even provided from different departments of a company or from different companies, are well and clearly defined, so that the customers understand the terminology and can easily find and select suitable products. The Feature Generator 10 reduces the failure rate on customer site to order the wrong product or service. This increases customer satisfaction and customer loyalty.

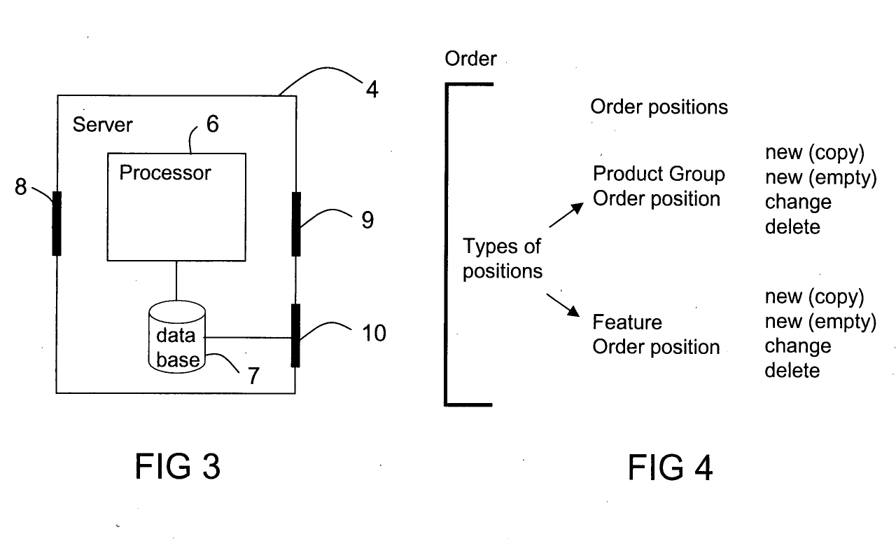

FIG. 3 shows an enlarged view of the server computer 4. The server computer 4 has at least one processor 6 for running an operating system, a run time system, and utility programs for controlling the interfaces 8, 9, 10. The interface 8 provides a connection to customers, the interface 9 provides a connection to at least one supplier. Advantageously, an interface comprises gateway functionality and HMI mechanisms (e.g. Web Browser, search mechanisms). Via the interfaces the customers and suppliers have access to the data base 7 comprising products with product features based on normed and standardized elements. The Feature Generator 10 also providing an interface to the data base 7 can be integrated into the interface 9. The Feature Generator 10 can also be implemented on a client computer 2 of the at least one supplier.

FIG. 4 shows an exemplary structure of an order to enter or change a feature or element of the data base 7 by means of the Feature Generator 10. The Feature Generator 10 can be used as an access mechanism for a product and/or service data base, as an access mechanism for an product or service catalog, or as an access mechanism for a feature data base, wherein the features are used to specify products or services, and wherein each feature contains characteristic elements based on standards or norms. Such order gives a person or a group of persons instructions how to modify the data base 7. An order is a hull or template comprising one or more order positions. There exist two types of order positions: product group order positions and feature order positions. For an order position four different processing variants are possible:

1. Order position new (copy)
Creating a new product group or a feature (label) on the base of an already existing product group or feature (label). Existing assignments will be transferred in into the order position.

2. Order position new (empty)
Creating a new product group or a feature (label).

3. Order position change
Changing of an existing order position. Assignments can be deleted partly or completely.

4. Order position delete
Deleting a product group or a feature (label).

An order is just a hull or template containing instructions how to change the data base. Changes and modifications of the data base are accomplished after a physical update of the data base. This ensures a controlled access to the data base.

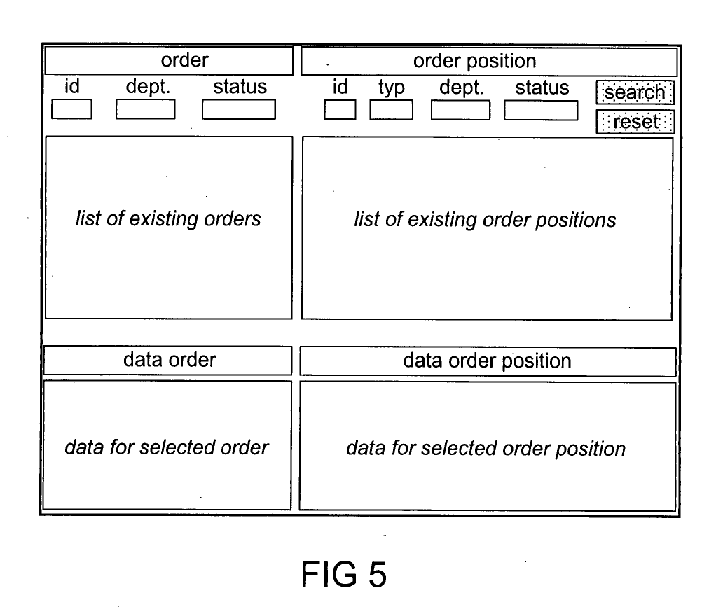

FIG. 5 shows an exemplary HMI of the feature or product group order management screen (search function). The HMI can be integrated into a server computer or a client computer. The HMI can be used for searching an order. The HMI shown in FIG. 5 provides a list of existing orders and a list of existing order positions according to a relevant order. In the bottom area of the HMI for each selected order and for each selected order position data in detail are displayed (e.g. time order entered, time order closed, submitter of the order, responsible department, time to finish order, among others). The HMI of the order management can be used to search an order, to define and submit an order, to track an order, etc. The HMI can be provided by a commercial Browser accessed by a hyperlink of the Internet or an intranet. Typically, access is protected by authorization mechanisms (e.g. passwords and user names).

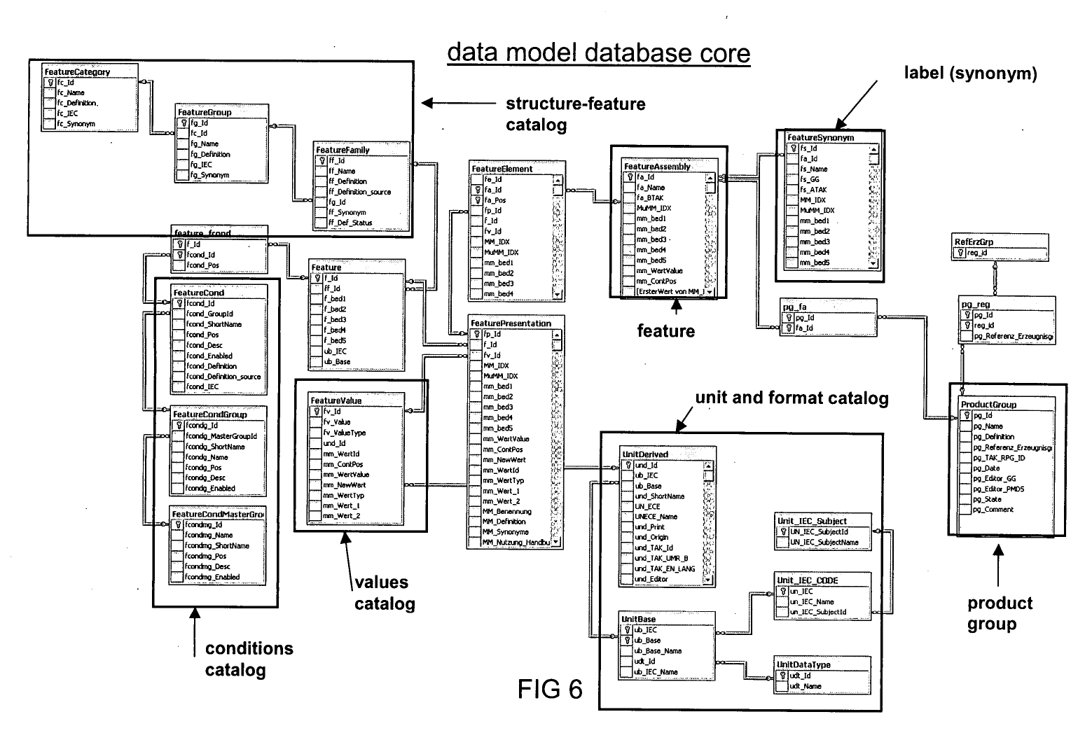

FIG. 6 shows an example of the data model of the data base core in an object oriented notation.

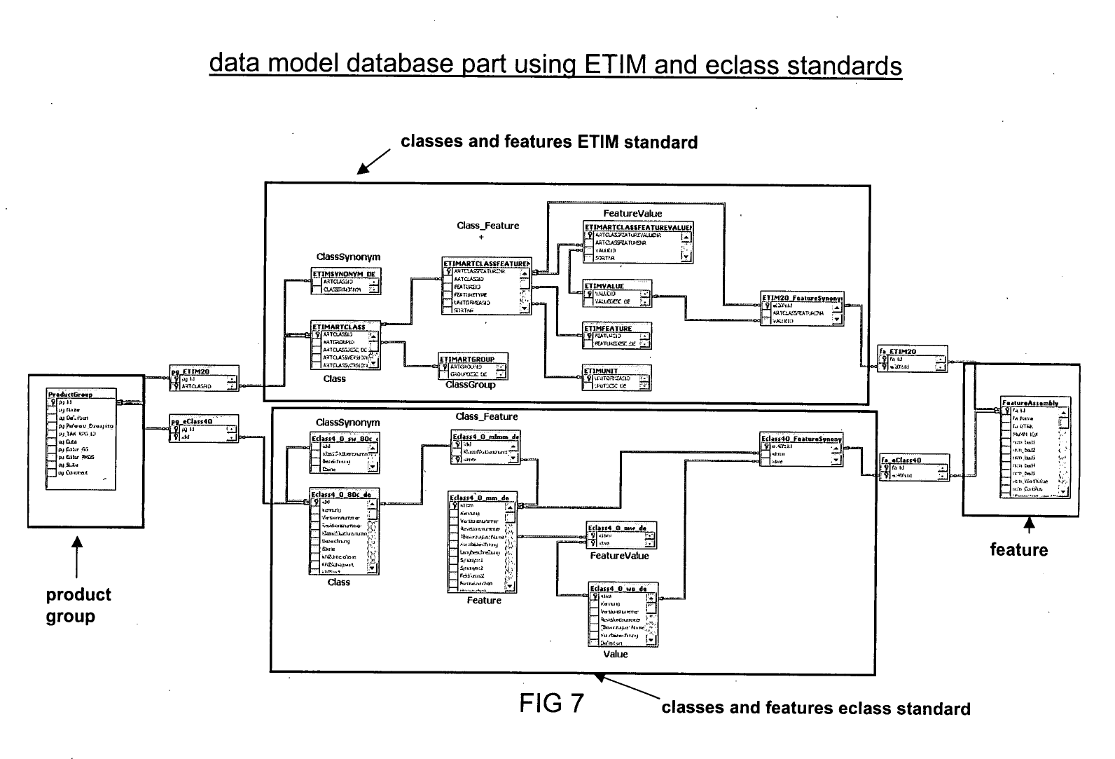

FIG. 7 shows a further example of the data model of the data base part using ETIM 2.0 and Eclass 4.0 standards in an object oriented notation.

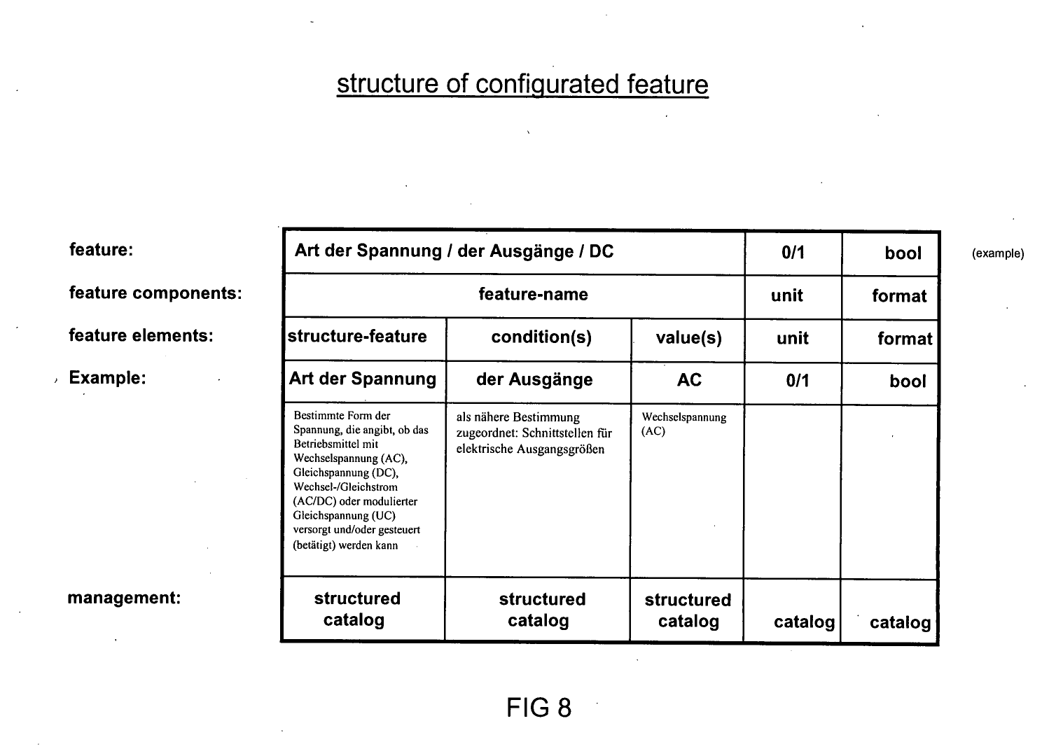

FIG. 8 shows an exemplary structure of a configurated feature.

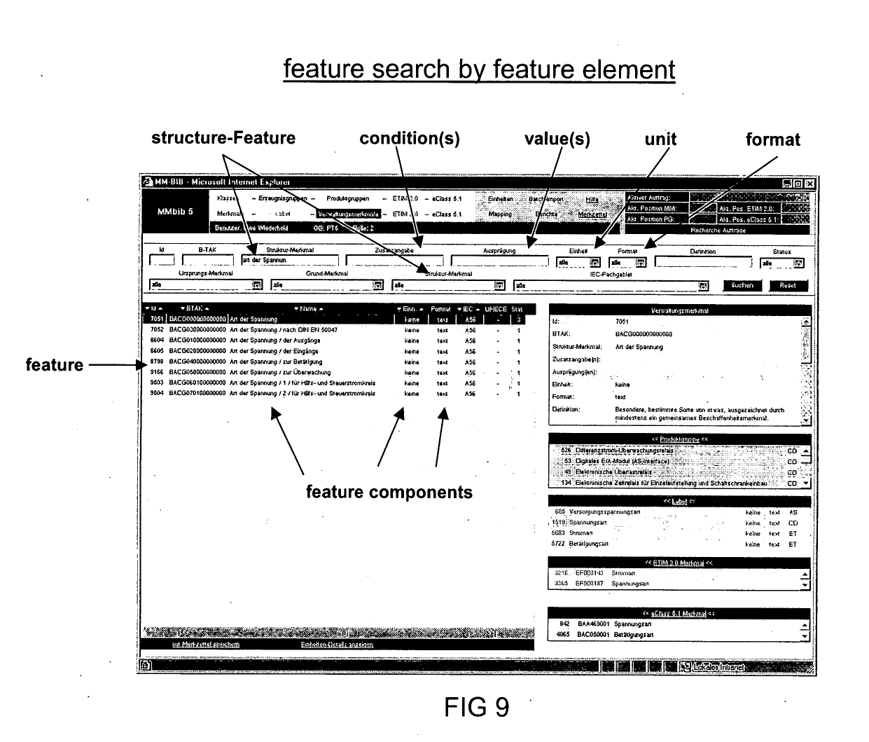

FIG. 9 shows an exemplary HMI for feature search by feature element.

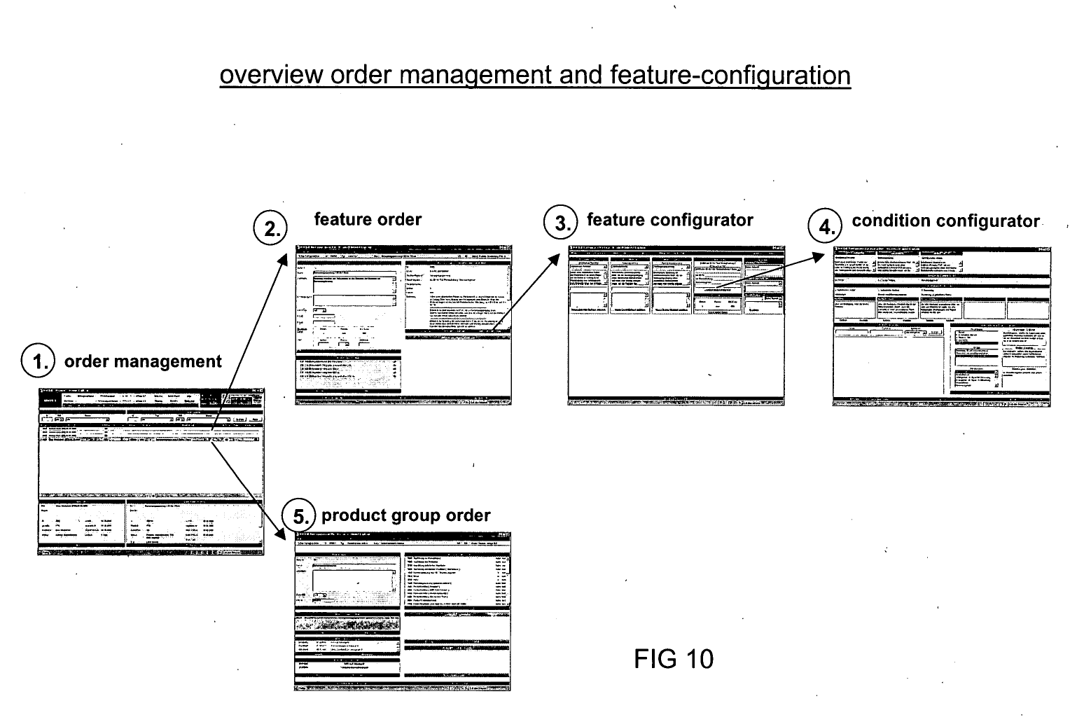

FIG. 10 shows in a schematic diagram an overview of an exemplary sequence in the order management and feature configuration.

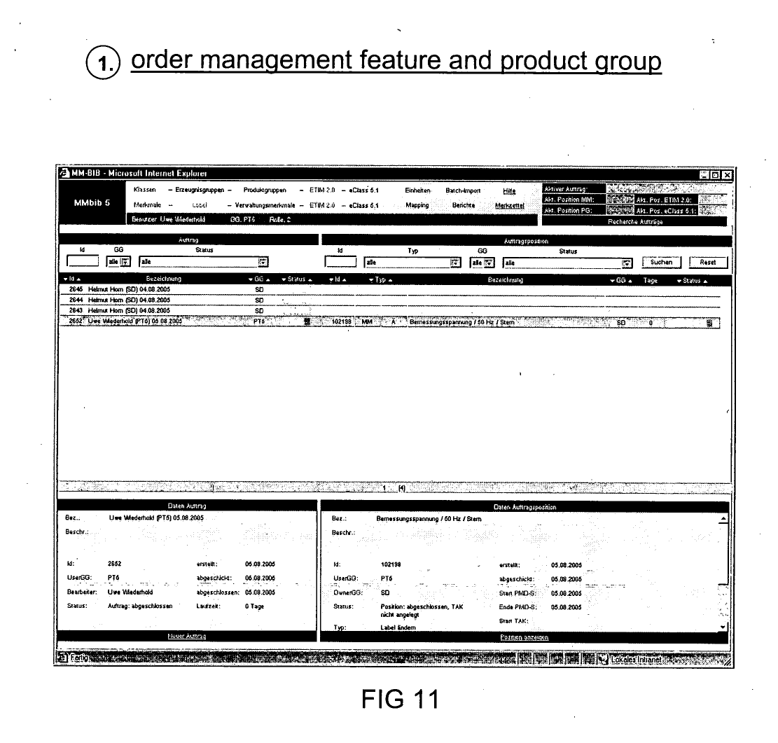

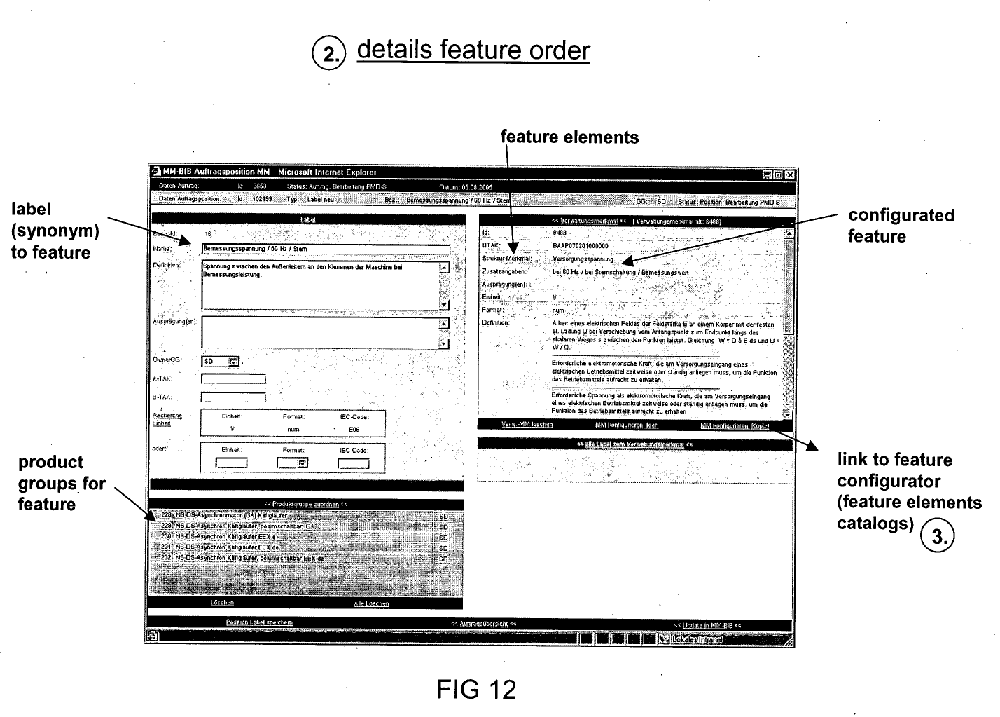

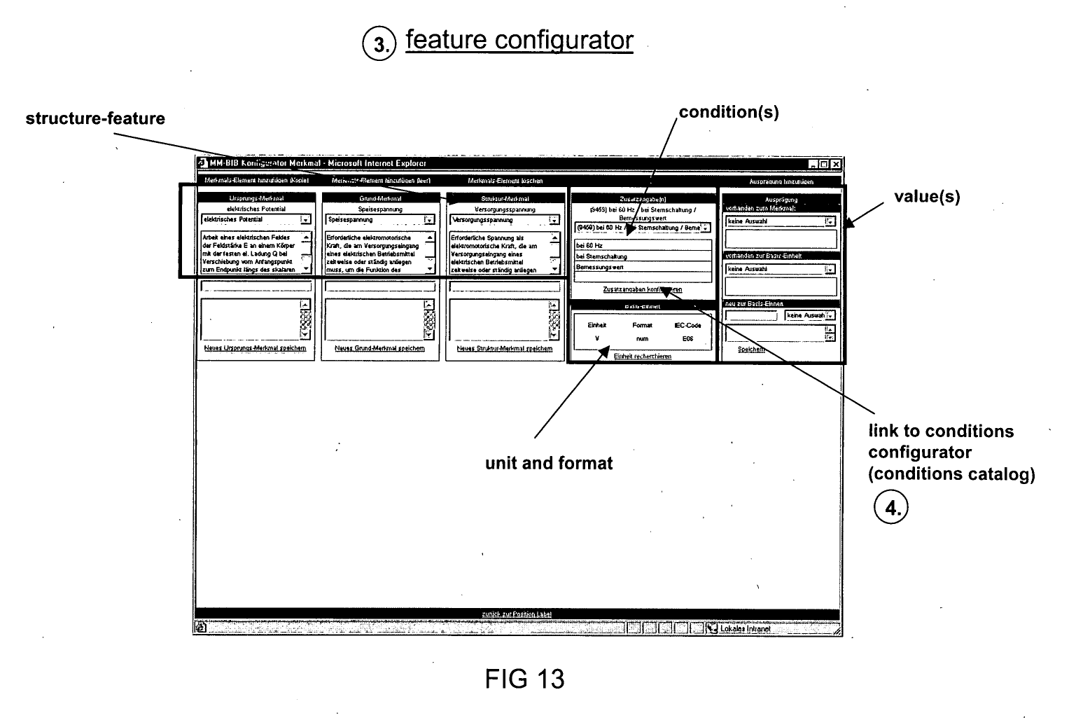

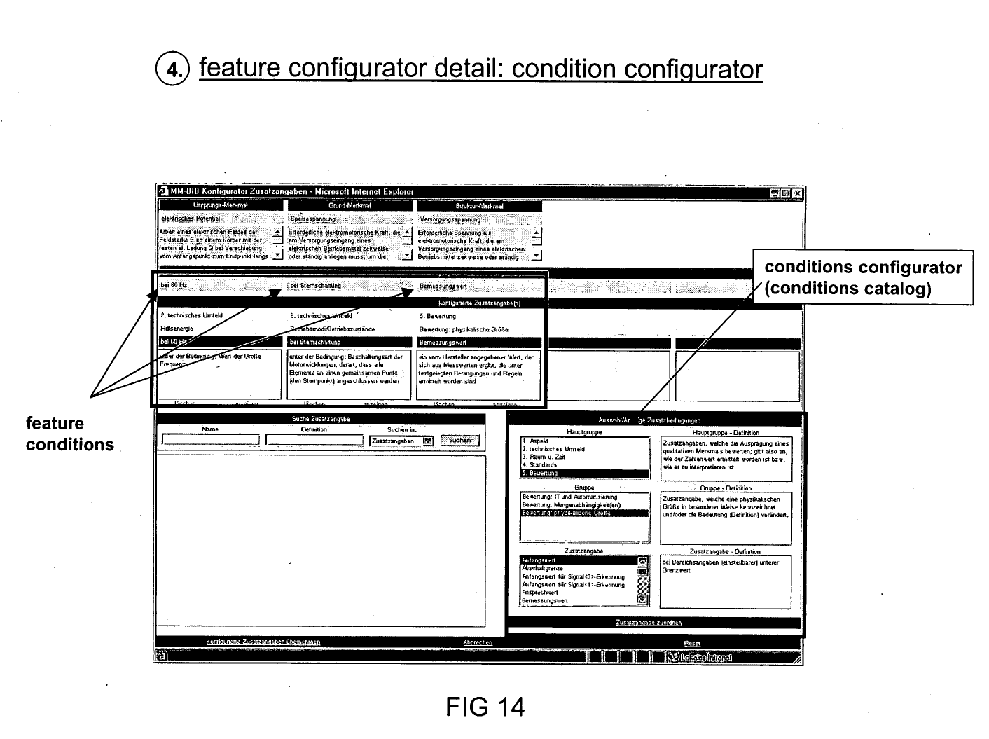

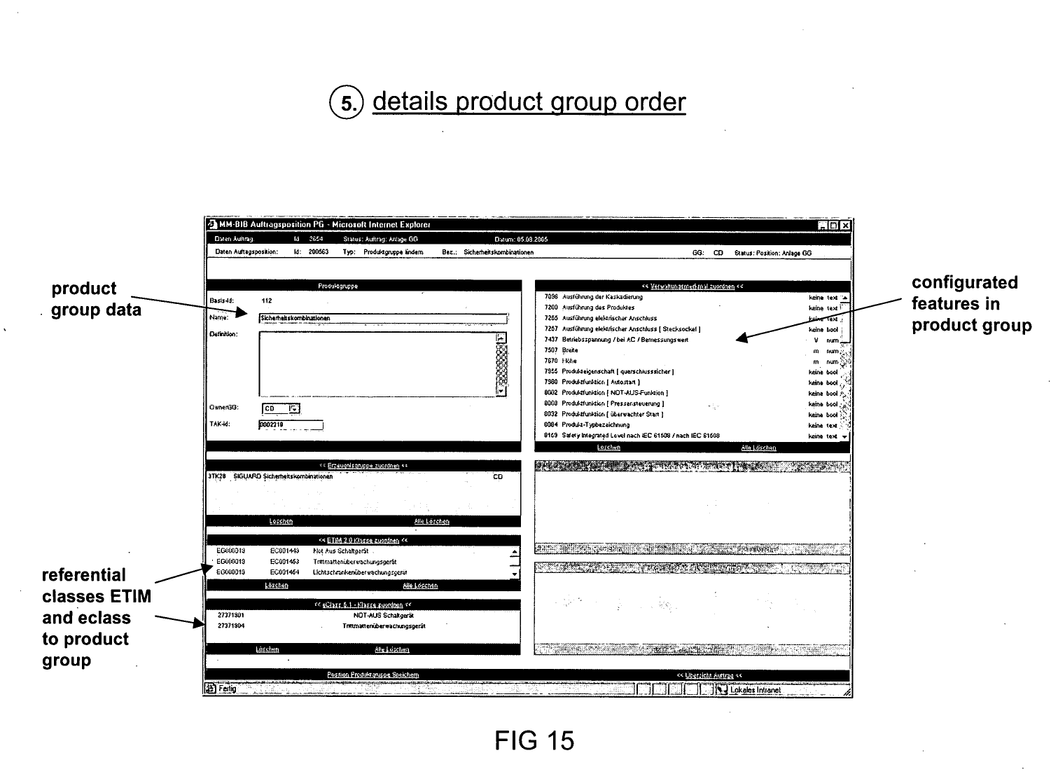

FIGS. 11-15 show in an exemplary chronology in the order management regarding a feature and product group.

We claim:

1. A method for norming and/or standardizing product features, wherein the product features are defined by characteristic elements, the method comprising:
providing a norm comprising characteristic elements regarding the product features;
providing a pool of product features and characteristic elements;
providing a search mechanism for defining a search pattern based on the norm, wherein the search pattern comprises the characteristic elements provided by the norm;
searching the pool based on at least one search pattern; and
modifying the pool of product features and characteristic elements by evaluating a hit list obtained by the search.

2. The method according to claim 1, further comprising:
providing a HMI for a user to access the pool of product features and characteristic elements, wherein
the HMI has an administration view offering a tool kit of predefined standardized elements which can be used to formulate a feature, and wherein
the HMI has a use view for identifying a feature or characteristic element of the administration view by using common terminology and/or wording of the user.

3. The method according to claim 2, wherein the use view provides a mapping from common terminology to standardized terminology of the administration view.

4. The method according to claim 2, wherein the search mechanism is integrated in the HMI.

5. The method according claim 1, wherein the search mechanism comprises a questionnaire.

6. The method according to claim 1, wherein the norm is an official standard.

7. The method according to claim 6, wherein the standard is ETIM, DIN V4002, IEC, or eClass.

8. The method according to claim 1, wherein the norm is an internal company norm.

9. The method according to claim 8, wherein the internal company norm is maintained and/or modified in a workflow operated by a work flow management system.

10. The method according to claim 1, wherein the product is a component for building and/or operating and/or maintaining a manufacturing facility, a power plant, a transportation system, or a consumer device.

11. The method according to claim 1, wherein the search mechanism comprises a search catalog designed as a web server application providing access to and from client applications and/or users.

12. The method according to claim 11, wherein the search catalog is an application of a Manufacturing Application System (MES).

13. The method according to claim 11, wherein the search catalog is integrated or connected to an Enterprise Resource and Planning (ERP) system.

14. The method according to claim 10, wherein the search catalog is implemented by using a Markup language.

15. The method according to claim 14, wherein the Markup language is HTTP or XML.

16. The method according to claim 1, wherein the pool of product features and characteristic elements is a relational data base, the Internet and/or an Intranet, and/or electronic auctions, and/or computer readable media, and/or further accessible media.

17. A system for norming and/or standardizing product features, wherein the product features are defined by characteristic elements, the system comprising:
a pool of product features and characteristic elements, wherein the features and characteristic elements are based on a norm or a standard;
a search mechanism for defining a search pattern based on the norm or the standard, wherein the search pattern comprises the characteristic elements provided by the norm or the standard; and
a mechanism for modifying the product features and characteristic elements by evaluating a hit list provided by the search mechanism.

18. The system according to claim 17, further comprising:
a HMI for a user to access the pool of product features and characteristic elements, wherein
the HMI has an administration view offering a tool kit of predefined standardized elements which can be used to formulate a feature, and wherein
the HMI has a use view for identifying a feature or characteristic element of the administration view by using common terminology and/or wording of the user.

19. The system according to claim 18, wherein the HMI comprises a mechanism for mapping common terminology of the use vies to standardized terminology of the administration view.

20. A method for searching a product, comprising:
providing a norm;
providing a search catalog including a plurality of search patterns based on the norm for searching products included in a product pool;
searching the product pool based on at least one search pattern;
modifying the at least one search pattern and the norm using an evaluation of a hit list obtained by the search; and
adapting the content of the norm according to the modified search pattern.
